(19) United States
(12) Patent Application Publication
(10) Pub. No.: US 2004/0006709 A1
(43) Pub. Date: Jan. 8, 2004

(54) Apparatus and method for securely inputting and transmitting private data associated with a user to a server

(75) Inventor: Ting-Huang Chen, Taipei (TW)

Correspondence Address: TROXELL LAW OFFICE PLLC, SUITE 1404, 5205 LEESBURG PIKE, FALLS CHURCH, VA, 22041, US

(73) Assignee: WAEI International Digital Entertainment Co., Ltd.

(21) Appl. No.: 10/335,900

(22) Filed: Jan. 3, 2003

(30) Foreign Application Priority Data
Jul. 2, 2002 (TW) 091114664

(51) Int. Cl. H04L 9/00

(52) U.S. Cl. 713/201

(57) ABSTRACT

The invention provides a data processing system and method for securely inputting and transmitting user's private data through a user terminal to a server. The user terminal comprises a display means and a designating means. The private data comprises input-codes. The apparatus comprises a receiving module and a processing module. The receiving module receives a request information from the user terminal. The request information indicates the request of inputting the private data. The processing module, responsive to the request information, generates a key arrangement definition and a virtual keyboard. The key arrangement definition defines a key arrangement. The virtual keyboard represents an image of the key arrangement displayed on the display means, and enables the user to input the private data by designating, by using the designating means, input-positions which each corresponds to one of multiple keys indicated in the image of the key arrangement displayed on the display means. For receiving the input-positions, transfer the input-positions into input-codes to obtain the private data consisting of the input-codes according to the key arrangement definition, and transmit the private data to the server wherein each of the input-codes corresponds to one of the keys indicated in the image of the key arrangement.

### FIELD OF THE INVENTION

The present invention relates to a data processing system and method for transmitting user's data to a server; in particular, a system and method for securely inputting and transmitting private data associated with the user to the server.

### BACKGROUND OF THE INVENTION

The Trojaned system commands (or the Backdoor program) is a hidden computer virus. The virus is smuggled with mails, files, or programs, and invades users' computers when users download mails, files or programs on the Internet. There are two kinds of damages by such virus. One is to destroy computer files; the other is to capture users' important private data. The Trojaned pretends to be a normal program, but actually changes the original programs stealthily and creates special system backdoors. The virus then can control users' computers or destroy users' files via these backdoors.

The common computer virus destroys computer files. The Trojaned is different from the common computer virus for that the Trajaned can capture and record information inputted by users. Therefore, users' private data are quietly transmitted to the invaders. Such kind of Trojaned are also called Key-Log program.

The key-log program provides the invader a convenient way to capture the users' private files or data, such as passwords or banking account numbers. The key-log program captures and records important information behind users' consciousness when the users use their private account names and passwords. Then, the key-log program transmits the important data to the invader through networks. The invader gets users' private data without any efforts. After this, the invader can use the data to do something illegal under users' names or to buy stuff using users' money. It is considered Internet crimes, and users become victims unconsciously. Nevertheless, it is very difficult to find out the real invader.

Users input their information by using keyboard or virtual keyboard on a screen via a mouse or light pen. When the mouse or light pen clicks on the words, word information is transmitted to a computer. The key-log program can then capture the transmitted word information from the real keyboard or virtual keyboard, and get users' private data.

It is very hard to find the key-log program, because there is not any weird phenomenon when the key-log program is working. Users are not aware of the invaders until getting unusual bills. And damage has been made.

The present invention is to provide a method to prevent the key-log program from capturing any useful information. Even users' computers are installed with the key-log program; they don't need to be worry about their private data to be stolen. The invention further avoids Internet crimes.

### SUMMARY OF THE INVENTION

It is therefore a primary objective of the present invention to provide a system and method for securely inputting and transmitting private data associated with a user to a server. This invention prevents the key-log program from capturing users' private data and further prevents Internet crimes.

This present invention provides a data processing apparatus for securely inputting and transmitting a private data associated with a user through a user terminal operated by the user to a server. The user terminal comprises a display means and a designating means. The private data consists of at least one input-code. The apparatus comprises a receiving module and a processing module. The receiving module receives a request information from the user terminal. The request information indicates the request of inputting the private data. The processing module, responsive to the request information, generates a key arrangement definition and a virtual keyboard. The key arrangement definition defines a key arrangement. The virtual keyboard represents an image of the key arrangement displayed on the display means, and enables the user to input the private data by designating means. By using the designating means, each of the at least one input-position corresponding indicates one of multiple keys in the image of the key arrangement displayed on the display means. The processing module receives the at least one input-position. The processing module transfers, according to the key arrangement definition, the at least one input-position into the at least one input-code to obtain the private data consisting of the at least one input-code, and transmits the private data to the server. Wherein each of the at least on input-code corresponds to one of the multiple keys indicated in the image of the key arrangement displayed on the display means.

It is an advantage of the present invention that the input-codes only exist in the computer or the server rather than the transmitting procedure. The invention will prevent the key-log program from capturing the word information during the transmitting procedure, and hence prevents the key-log program from capturing the user's inputting private data and from a serious lose.

These and other objectives of the present invention will no doubt become obvious to those of ordinary skill in the art after the following detailed description of the preferred embodiment, which is illustrated in the various figures and drawings.

### BRIEF DESCRIPTION OF THE APPENDED DRAWINGS

FIG. 1 is a schematic diagram of the data processing apparatus according to the present invention.

FIG. 2 is a flow chart of the data processing method according to the present invention.

### DETAILED DESCRIPTION OF THE INVENTION

The present invention provides a data processing apparatus and method for securely inputting and transmitting private data associated with a user to a server.

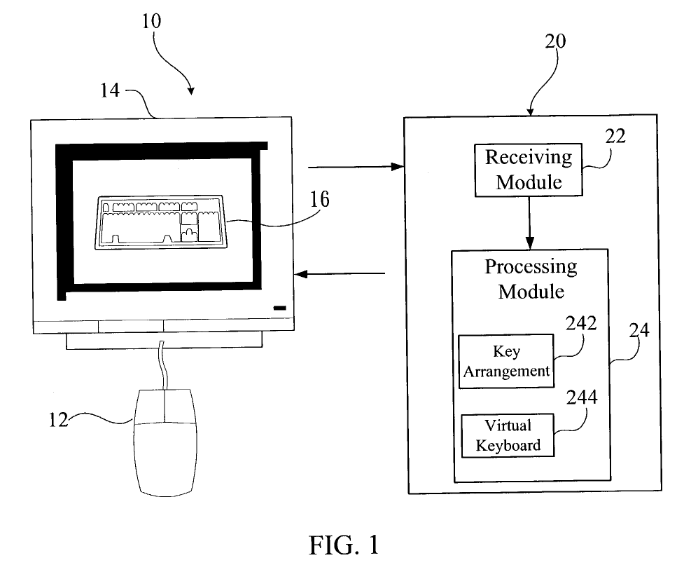

Please refer to FIG. 1. FIG. 1 is a schematic diagram of the data processing apparatus 20 according to the present invention. The data processing apparatus 20 is provided for securely inputting data through a user terminal 10, and transmitting the data to a server (not shown). The user terminal 10 is operated by the user. The user terminal 10 comprises a designating means 12 and a display means 14.

The data processing apparatus 20 comprises a receiving module 22 and a processing module 24. The receiving module 22 is implemented by a GUI-based browser. The receiving module 22 receives a request information from the user terminal 10. The request information indicates the request of inputting the private data. The processing module 24, responsive to the request information, generates a key arrangement definition 242 and a virtual keyboard 244. The key arrangement definition 242 defines a key arrangement. The virtual keyboard 244 is implemented by a Script application or other similar programs that can simulate the input of a keyboard. The virtual keyboard represents the key arrangement and displays a keyboard image 16 on the display means 14.

The key arrangement definition 242 defines the image size, position, and arrangement of keys of the key arrangement displayed on the display means 14. The definition defined by the key arrangement definition 242 can be changed. The definition may be different according to different time or users.

By using the designating means 12, the user designates several input-positions on the keyboard image 16. Each input-position corresponding indicates one of multiple keys in the keyboard image 16. The user can also designate one or several input-positions to input data by the designating means 12 based on the user's need.

The designating means 12 can be a mouse or a light pen. The designating means 12 also can be simulated by the real keyboard, but the way of key-in is different from the real keyboard. Besides, the display means 12 may include a touchable screen touched directly by the light pen or the user's finger. The keyboard image 16 may comprise the key image of a general keyboard with it's key arrangement. Or the keyboard image 16 can be other key images that can be identified by the user, such as numbers, letters, phonetic symbols, and have special arrangements.

When the user wants to securely input and transmit his data, the user input desired words to the designating means 12 rather than the real keyboard, or to the designating position via the real keyboard. The word information is further inputted to the virtual keyboard 244. Because the word-code doesn't run on the real keyboard, the key-log program cannot capture the word-code from the real keyboard.

When the user wants to transmit a private data and designates the input-positions for inputting data, the processing module 24 receives the input positions and transfers the input-positions to several input-codes according to the key arrangement definition 242. Then the processing module 24 obtains the private data consisting of these input-codes, and transmits the private data to the server subsequently.

Each of the input-codes corresponding indicates one of the multiple keys in the keyboard image 16. With the virtual keyboard 244 via the keyboard image 16, what is transmitted is not the traditional word information, but the information on the corresponding positions on the virtual keyboard 244. After the position information is transmitted to the processing module 24, the processing module 24 will transfer the position information to an input-code according to the definition defined by the key arrangement definition 244.

In one embodiment, the key arrangement definition 242 and the virtual keyboard 244 is implemented in a remote place away from the user terminal 10, for example in a remote server. Under the circumstance, the user terminal 10 only transmits the position information rather than the input-codes to the server. Even the key-log program exists in the user terminal; it can only capture the position information rather than the word information. This invention can prevent the user's private data from being stolen.

In another embodiment, the key arrangement definition 242 and the virtual keyboard 244 is implemented in the user terminal 10. Under the circumstance, even the key-log program is exists in the user terminal, it can only capture the position information rather than the word information. For the transmition between the user terminal and the remote server becomes more secure, the invention prevents the user's private data from being stolen.

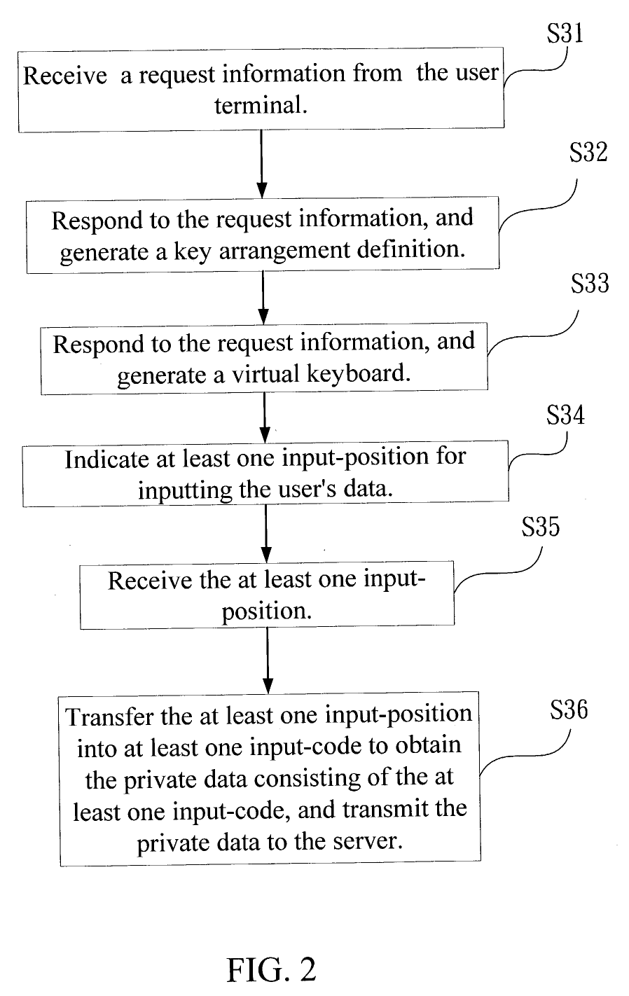

Please refer to FIG. 2. FIG. 2 is a flow chart of the data processing method according to the present invention. The data processing method comprises the following steps:

Step S31: receiving a request information from the user terminal 10; the request information indicating the request of inputting the private data;

Step S32: responding to the request information, and generating a key arrangement definition 242;

Step S33: responding to the request information, generating a virtual keyboard 244 representing the key arrangement definition 242, and displaying the keyboard image 16 on the display means 14;

Step S34: indicating at least one input-position for inputting the user's data;

Step S35: receiving the at least one input-position;

Step S36: according to the key arrangement definition 242, transferring the at least one input-position into the at least one input-code to obtain the private data consisting of the at least one input-code, and transmitting the private data to the server.

Comparing with the prior art, the input-codes of the invention only exist in the computer or the server rather than the transmitting procedure. The method will prevent the key-log program from capturing the word information. The data processing apparatus of the present invention is particularly suitable for processing private data like banking account numbers, passwords, etc. The invention prevents the key-log program from capturing the user's inputting private data, and from a serious lose.

The data processing apparatus of the present prevents key-log by the key-log program. The invention prevents the user from being stolen the private data unconsciously, and further prevents from a serious lose and making crimes by the invader. Thus the present invention has not only the novelty and non-obviousness, but also the utility. It is a very practical and meaningful new creation.

Those skilled in the art will readily observe that numerous modifications and alterations of the device may be made while the teaching of the invention. Accordingly, the above disclosure should be construed as limited only by the metes and bounds of the appended claims.

What is claimed is:

1. A data processing apparatus for securely inputting and transmitting a private data associated with a user through a user terminal operated by the user to a server, the user terminal comprising a display means and a designating means, the private data consisting of at least one input-code, said apparatus comprising:
a receiving module for receiving a request information from the user terminal, the request information indicating the request of inputting the private data;
a processing module, responsive to the request information, for generating
a key arrangement definition defining a key arrangement, and
a virtual keyboard representing an image of the key arrangement displayed on the display means, and enabling the user to input the private data by designating means, by using the designating means, each of the at least one input-position corresponding indicated one of the multiple keys in the image of the key arrangement displayed on the display means,
for receiving the at least one input-position, transferring, according to the key arrangement definition, the at least one input-position into at least one input-code to obtain the private data consisting of the at least one input-code, and transmitting the private data to the server, and wherein each of the at least on input-code corresponding indicated one of the multiple keys in the image of the key arrangement displayed on the display means.

2. The data processing apparatus of claim 1, wherein the key arrangement definition also defines a size of the image of the key arrangement displayed on the display means.

3. The data processing apparatus of claim 1, wherein the key arrangement definition also defines a position of the image of the key arrangement displayed on the display means.

4. The data processing apparatus of claim 1, wherein the virtual keyboard is implemented by a Script application.

5. The data processing apparatus of claim 1, wherein the receiving module is implemented by a GUI-based browser.

6. A data processing method for securely inputting and transmitting a private data associated with a user through a user terminal operated by the user to a server, the user terminal comprising a display means and a designating means, the private data consisting of at least one input-code, said method comprising the steps of:
receiving a request information from the user terminal, the request information indicating the request of inputting the private data;
responsive to the request information, for generating
a key arrangement definition defining a key arrangement, and
a virtual keyboard representing an image of the key arrangement displayed on the display means, and enabling the user to input the private data by designating means, by using the designating means, each of the at least one input-position corresponding indicated one of multiple keys in the image of the key arrangement displayed on the display means;
receiving the at least one input-position;
according to the key arrangement definition, transferring the at least one input-position into at least one input-code to obtain the private data consisting of the at least one input-code, and transmitting the private data to the server, and wherein each of the at least one input-code corresponds to one of the multiple keys indicated in the image of the key arrangement displayed on the display means.

7. The data processing method of claim 6, wherein the key arrangement definition also defines a size of the image of the key arrangement displayed on the display means.

8. The data processing method of claim 6, wherein the key arrangement definition also defines a position of the image of the key arrangement displayed on the display means.

9. The data processing method of claim 6, wherein the virtual keyboard is implemented by a Script application.

10. The data processing method of claim 6, wherein the receiving module is implemented by a GUI-based browser.
